(19) United States
(12) Patent Application Publication
(10) Pub. No.: US 2002/0075308 A1
(43) Pub. Date: Jun. 20, 2002

(54) Multi-purpose interactive application execution system

(76) Inventors: Adam W. Divelbiss, Mohegan Lake, NY (US); David C. Swift, Cortlandt, NY (US)

Correspondence Address: Reveo, Inc., 85 Executive Blvd., Elmsford, NY, 10523, US

(21) Appl. No.: 09/879,557

(22) Filed: Jun. 12, 2001

Related U.S. Application Data
(62) Division of application No. 09/135,896, filed on Aug. 18, 1998, now abandoned.
(60) Provisional application No. 60/065,122, filed on Nov. 12, 1997.

(51) Int. Cl. G09G 5/00

(52) U.S. Cl. 345/762; 345/764; 345/733

(57) ABSTRACT

A multi-purpose interactive application execution system (MPIAE) provides a platform for a wide variety of applications having differing hardware and software requirements. The MPIAE system may support applications in many different fields, from video-gaming to helping the handicapped. This range of applications is made possible by flexibility of software and hardware resident within the MPIAE system. The software of the MPIAE system includes a variety of drivers equipped to interface with a large number of possible input signals. The hardware of the MPIAE system includes many different types of industrial grade controls which allow for a large number of input possibilities.

This application claims the benefit of U.S. provisional application No. 60/065,122, filed Nov. 12, 1997.

### BACKGROUND OF THE INVENTION

In general, this invention relates to providing a system for running various applications. Specifically, the multi-purpose interactive application execution system (MPIAE) provides versatility in programming and executing applications, which may require a variety of possible environments, on a single system.

Video gaming is one particular area where versatility in programming and executing applications is important. In March 1997, Intel announced a new computer platform standard called the Open Arcade Architecture (OAA). The OAA is essentially a set of specifications for hardware to be used in arcade games. The OAA is one way to bring the tremendous content versatility of high-end PC games to the coin-op and location-based entertainment (LBE) industries by raising the systems requirements of arcade games. Future games and gaming platforms supporting the OAA architecture will provide operators and owners of video arcades, high-tech LBE sites, and other similar facilities with the capability of changing content without changing their hardware. The OAA platform is based upon a non-proprietary PC-compatible architecture that uses the Intel Pentium II microprocessor with MMX technology. The specification gives guidelines for video cards, sound cards, input/output devices, network connectivity, non-subvertable user interfaces, and other system features. The operating software is specified as either Windows 95, Windows 98, or Windows NT.

Two items of great importance not covered by the proposed OAA standard are support for legacy (pre-existing) high-end PC computer games and support for legacy console system games (Nintendo, Sega Genesis, Sony Play Station, etc.) The popularity and success of these games is clearly indicated by their huge installed base in consumer homes.

Arcade console systems make up most of the typical arcade games. These systems are generally based upon a stand-up kiosk design with a large main view screen, speakers, and controls for one or two players. These devices are universally based on proprietary hardware from companies like Sega, Namco, Konami, etc. The arcade console games come in numerous shapes and sizes depending upon the application and theme (e.g., racing, motorcycle, shooting, etc.)

Some of the problems and shortcomings of the traditional arcade console games are that the game content is tied to console hardware and the console hardware is not reconfigurable to different games, nor is the theme changeable. Also, these games are expensive and not able to be networked, though some consoles provide head-to-head play for up to four people. Finally, a limited variety of game themes exist. In fact, one of the recurrent problems of video arcade industry platforms is the inability to change content without investing in a new and expensive machine.

Further content offerings are not only limited in theme but in functionality as well. Functionality is limited in that there are typically no skill levels available, it is not possible to save a game and retrieve it later, and the games are not networked across the facility.

In the video arcade industry the standard method of changing game content is by changing the hardware platform. This action is costly to the small owner/operator in addition to being very inconvenient. Further application content for video arcades, theme parks etc., is platform specific. That is, it is designed to be run on a particular brand of standup kiosk system. This fact is due to the proprietary nature of the content and platforms existing today. In addition to these problems, the hardware platform is generally incapable of executing more than one content application. Finally there is no coin-op or arcade platform capable of executing legacy PC content or home console system game content.

The high-end LBE industry has many of the same problems as the video arcade industry. High-end LBE systems come in many varieties and capacities from fully or partially enclosed low capacity capsules, to higher capacity open-platform based motion theaters. Because these LBE systems are typically higher in price and less in number than the video arcade systems, the content offering is proportionately smaller and typically proprietary as well.

In view of the foregoing, it would be desirable to provide a system capable of running various applications which possess differing hardware and software requirements.

It would further be desirable to provide a system capable of running various video arcade games which possess differing hardware and software requirements, without requiring substantial changes to the system.

It would be still further desirable to provide a system capable of running various high-end PC and console games which possess differing hardware and software requirements, without requiring substantial changes to the system hardware.

It would be yet further desirable to provide a system capable of acting as a platform for future, as yet undeveloped, software and hardware applications.

### SUMMARY OF THE INVENTION

It is an object of this invention to provide a system capable of running various applications which possess differing hardware and software requirements.

It is a further object of this invention to provide a system capable of running various arcade games which possess differing hardware and software requirements, without requiring substantial changes to the system.

It is a still further object of this invention to provide a system capable of running various high-end PC and console games which possess differing hardware and software requirements, without requiring substantial changes to the system hardware.

It is yet a further object of this invention to provide a system capable of acting as a platform for future, as yet undeveloped, software and hardware applications.

The MPIAE system solves each of these problems by providing a means to execute a wide variety of applications on the same hardware system. Furthermore, the hardware of the MPIAE system may be modified and changed to add new features to the application. For instance, it is possible to develop gaming applications with multiple added features like motion feedback, force feedback, two-way audio/video communication, smell, heat/cold, humidity, and many others.

The MPIAE system solves these problems through the use of advanced software drivers and a variety of hardware options. The MPIAE system supports a wide range of applications that may require a unique platform for their individual software and hardware. A wide variety of legacy video games based on DOS, Windows 95, Windows 98 and Windows NT systems equipped with suitable input devices, and console application games may be played on the MPIAE system. In addition, these applications may include applications adapted to handicapped users or users challenged in other fashions. These users may take advantage of the various input environments offered by the MPIAE system, as will be explained.

In one preferred embodiment, as applies to video-gaming, the MPIAE system allows users to play legacy, as well as future, high-end PC-based games and applications. In addition, console system games such as Nintendo 64, Sony Play Station, and Sega Saturn game applications may be executed through the MPIAE system. The types of environments in which applications can be executed through the MPIAE system include, but are not limited to, standup kiosks, immersive enclosed capsules, interactive motion simulator systems, interactive theaters, and immersive multiple screen systems. The ability to execute and interact with the vast number of applications provided on each of these and future platforms makes the MPIAE system a powerful tool for use in coin-op arcades, family entertainment centers, theme parks, cyber cafes, malls and shopping centers, and even at home.

An MPIAE system for executing applications is provided. The system comprises means for selecting, setting up, executing, verifying and reverifying the state of the application, and closing the application. The system also comprises a means for interfacing an application, whether legacy, console, or future, to a single human user or multiple human users and providing a means for the addition of features and effects, not part of the application's original design, without altering the application in any way.

In one embodiment, the system comprises an application execution and control unit subsystem, an output subsystem, a local secondary application subsystem, and a network communications unit.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is a block diagram of a Multi-Purpose Interactive Application Execution (MPIAE) system according to the present invention;

FIG. 2 is a block diagram of an application execution and control unit according to the present invention;

FIG. 3 is a block diagram of an interface management system according to the present invention;

FIG. 4 is a block diagram of an application management system according to the present invention;

FIG. 5 is a block diagram of an application execution and control unit in a legacy application configuration according to the present invention;

FIG. 6 is a block diagram of an application execution and control unit in a console application and audio/video playback configuration according to the present invention;

FIG. 7A is a general software flowchart according to the present invention;

FIG. 7B is a software flowchart according to the present invention;

FIG. 8 is a block diagram of an MPIAE system configured for the Internet according to the present invention;

FIG. 9 is a perspective view of the structure of a game pod according to the present invention;

FIG. 10 is a perspective view of a partially covered game pod according to the present invention;

FIG. 11 is a perspective view of a completely covered game pod according to the present invention; and

FIG. 12 is a top plan view of user controls according to the present invention.

### DETAILED DESCRIPTION OF THE INVENTION

The MPIAE system is divided into five subsystems in order to provide a functional interface between a human user and an application. These systems include an input subsystem, a local secondary application subsystem, an output subsystem, a network communications unit, and an application execution and control unit (AECU).

The AECU serves as the primary application execution unit. It controls the interface between the resident application and the human user, other MPIAE systems, and other secondary application execution units. Functions of the AECU may be provided by a single high-end PC or other suitable execution unit.

The network communications unit enables high-speed communications to other MPIAE systems on a local area network. The network communications unit may also provide application and file serving functions between MPIAE systems and servers. In one embodiment of the invention, the network communications unit may link a local group of MPIAE systems to the Internet or other suitable wide area network.

The input subsystem receives input from a user or users and transfers the input to the AECU which adapts the input for use by the resident application. One application utilizing input from multiple users may include an MPIAE system embodied in an interactive theater. The output subsystem performs the opposite of the actions of the input subsystem by transferring output information from the AECU to the user.

The local secondary application subsystem provides support for alternative application execution platforms. This subsystem provides the capability of running non-interactive content applications from laser disc or DVD players, or running interactive content applications from console based systems. Moreover, when providing a platform for console based systems, the local secondary application subsystem may preferably substitute the console for the AECU. The application then resides in the console and not in the AECU, though the functions of interfacing with the MPIAE are still coordinated by the AECU.

The AECU utilizes two main components to provide a platform for applications. The first is the interface management system (IMS) and the second is the application management system (AMS).

The application management system guides the application through the processes of application selection, execution, and exit. The application management system accomplishes these tasks by configuring the input and output subsystems, coordinating launching of the application, and tracking the state of the application throughout its use.

The interface management system coordinates the interface between applications, the MPIAE, and a user. It provides various drivers for supporting legacy and future applications, software wrappers and software simulators for control of different hardware devices, and hardware that interfaces with actual legacy, future, and console hardware devices. The interface management system also provides the function of interfacing an application to a user or users by providing a means for the addition of features and effects not included in the original design of the application.

Typically, in the case of a legacy application, the application is unaware of the MPIAE and its added features. Therefore, the application management system relies on its own stored data concerning the specific legacy application, as well as various tools of the interface management system, to make assumptions concerning the proper configuration of the AECU.

In the case of a future application, the application preferably recognizes and connects to the application management system and the interface management system. In addition, a future application can make direct connections to output and input subsystems without using the application management system or the interface management system. However, the connections between the future application with either the application management system or the interface management system preferably take precedence over the direct connections to the input and output subsystems in order to allow the MPIAE to control the application.

In the secondary application mode (i.e., a console application or any local application not residing in the AECU,) the application to be executed resides completely in the local secondary subsystem. If the secondary application system is aware of the interface management system, it can control input/output system functions and report state information to the application management system via the interface management system. Interface management system awareness preferably provides greater application control and system reliability. Thus, the main difference between a primary application and a secondary application is the area of residence and configuration of the AECU.

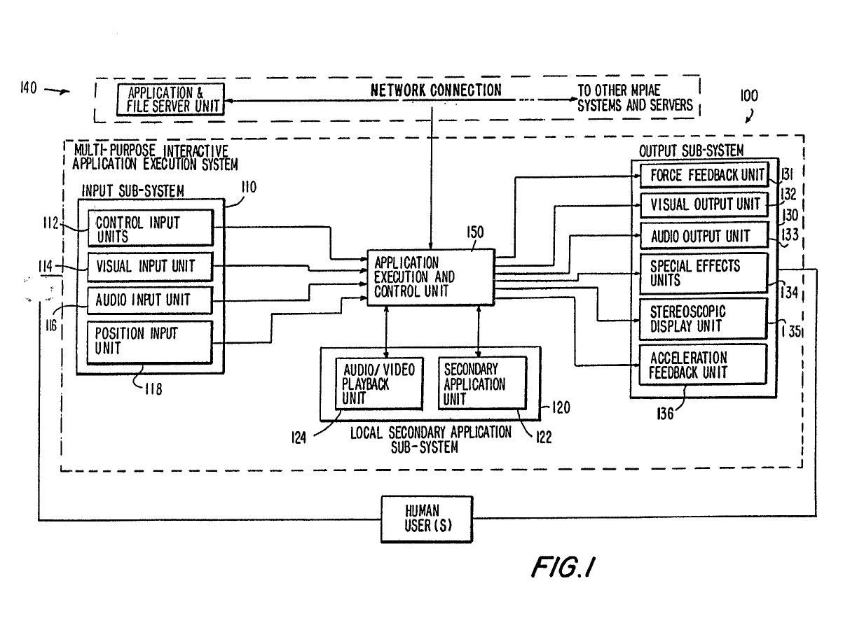

FIG. 1 shows a basic functional block diagram of the MPIAE system 100. The figure shows MPIAE system 100 in the form of a standard input/output diagram. A human user or users is shown receiving output from MPIAE 100 and inputting input. This figure demonstrates the functionality of the interface between the human being and MPIAE system 100. The system is divided into five subsystems including the input subsystem 110, the local secondary application subsystem 120, the output subsystem 130, the network communication unit 140, and the AECU 150. Each of these five subsystems are discussed below.

AECU 150 forms the heart of MPIAE system 100. This unit serves as the primary application execution unit. It controls and/or coordinates all interface to the application including input and output to the human user(s), input and output to other MPIAE systems, and input and output to the other secondary application execution units. Realization of this unit may be by a single high-end PC or other suitable execution unit.

The network communication unit 140 serves as the high-speed interface to other MPIAE systems on a local area network. This interface allows high speed communication between users of the MPIAE system as well as application and file serving between MPIAE systems and servers. In this manner, remote MPIAE systems may coordinate applications for other MPIAE systems on the same local area network. [The remote servers are called remote secondary application servers.] The network communications unit 140 may also serve as the direct link between a local group of MPIAE-based systems and the Internet or other wide area network.

The purpose of the input subsystem 110 is to receive input from a human user. The control input unit 112 of MPIAE system 100 is capable of receiving input from the user in a variety of methods including high quality industrial controls such as joysticks, foot pedals, steering wheels, buttons, throttles, flight yokes, touch screen displays and many others. Support for a visual input unit 114, such as a stereo or infrared camera, is provided. One purpose of the visual input unit 114 is to allow the user to visually communicate with other users. The audio input 116 provides an audio communication medium for the user. The position input unit 118 provides head tracking and other user position data for the system. Other input units and systems may be incorporated as well.

The purpose of the output subsystem 130 is to send information and stimuli to the human user. Output subsystem 130 of MPIAE 100 is capable of utilizing a wide variety of methods to transmit information to the human user. The force feedback unit 131 provides mechanical feedback to various user controls including the steering wheel, joystick, etc. This may be used to provide a sense of “feel” to the user. The visual output unit 132 provides visual stimulus to the user. It is used to display all types of visual information. The audio output unit 133 provides auditory stimulus to the user including sound effects and audio or verbal communication. The special effects unit 134 may provide a variety of other stimuli including temperature, humidity, lighting effects, fog effects, olfactory effects, and others. The stereoscopic display unit 135 provides visual stimulus in a stereoscopic format to the user. The acceleration feedback unit 136 provides the sensation of motion to the user. This unit can be used for multiple degree-of-freedom motion simulators.

The local secondary application subsystem 120 provides support for alternative application execution platforms that are part of a local system or that are integrated with an individual MPIAE system. Local secondary application subsystem 120, through the audio/video playback unit 124, also provides the capability of running non-interactive content from laser disc or DVD players. In addition, local secondary application subsystem 120, through the console application unit 122, provides the capability of running interactive content from a console based system such as Sony Play Station, Nintendo 64, Sega Genesis, and Sega Saturn systems. Other stand-alone systems may also be incorporated into this system.

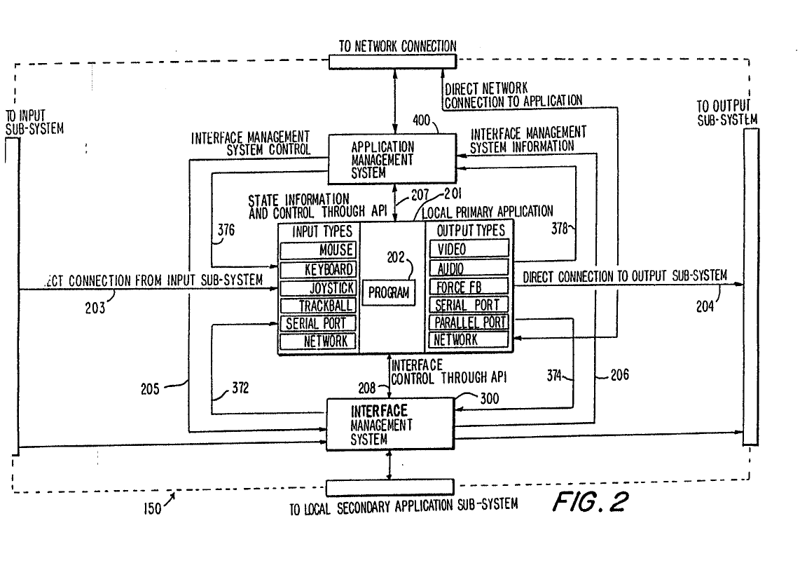

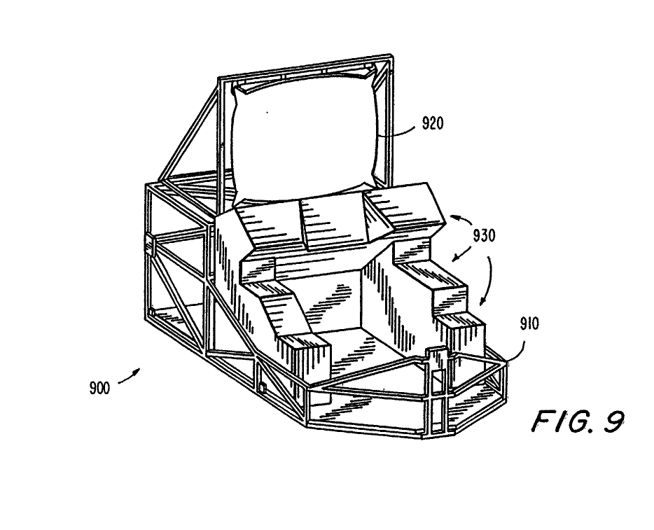

The AECU 150 is shown in greater detail in FIG. 2. It provides the central function of the invention, allowing a program 202 to function in the hardware/software environment provided by the invention. Local primary application 201 may utilize any one of a large number of inputs, including mouse, keyboard, joystick, trackball (see FIG. 9,) and serial port, as well as a large number of outputs including video, audio, force feedback, serial port, parallel port, and network outputs, depending upon the requirements of the application.

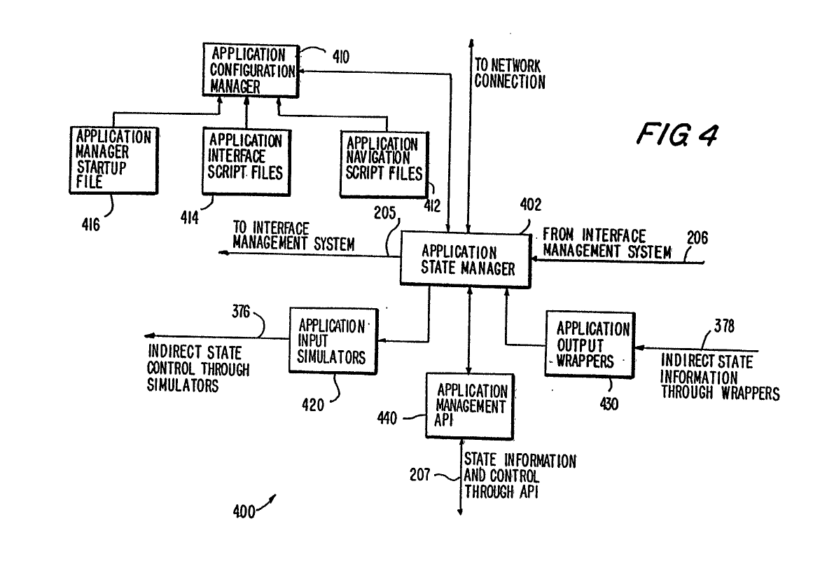

The AECU 150 accomplishes the goal of providing a platform for applications by utilizing two main components: The application management system (AMS) 400 and the interface management system (IMS) 300. The AMS (See FIG.4) configures the MPIAE system for operation and governs the state of both the local primary application 201, and the local secondary application subsystem 120. The IMS provides the resources to maintain the relationship of both the local primary application 201 and/or the local secondary application subsystem 120 with the various software drivers, hardware devices, and other system hardware active in MPIAE 100. In addition, AECU 150 has a direct connection to input subsystem 110, output subsystem 130, and network connection 140, as shown by the two horizontal connecting lines 203 and 204 in FIG. 2.

The AMS 400 and IMS 300 work together to provide a standard interface between the various application types (legacy and future, primary and secondary) and the input sub-system 110 and output sub-system 130. AMS 400 and IMS 300 utilize various input and output features and controls regardless of whether or not the application is aware of the MPIAE system. AMS 400 is responsible for the higher level functions of system configuration, application launch and termination, and application state management. IMS 300 is responsible for the lower level functions that provide the actual interface between the application and the input and output subsystems. Thus, IMS 300 creates an interface for an application that can be exploited by a user.

AMS 400 communicates directly with IMS 300 by sending commands and receiving information, as shown in FIG. 2 by connection lines 205 and 206. Both AMS 400 and IMS 300 communicate with the local application through either a direct or indirect method. Direct communication between the local primary application is provided by an Application Programming Interface (API) (see connection lines 207 and 208 in FIG. 2.) The application is MPIAE-aware if this direct connection exists. If no direct communication exists, indirect communication occurs through local primary application input simulators (see connection lines 372, 376) and local primary application output wrappers (see connection lines 374, 378.) All communication between the AECU and the local secondary application subsystem is through IMS 300. Thus, IMS 300 creates an interface for an application that can be exploited by a user.

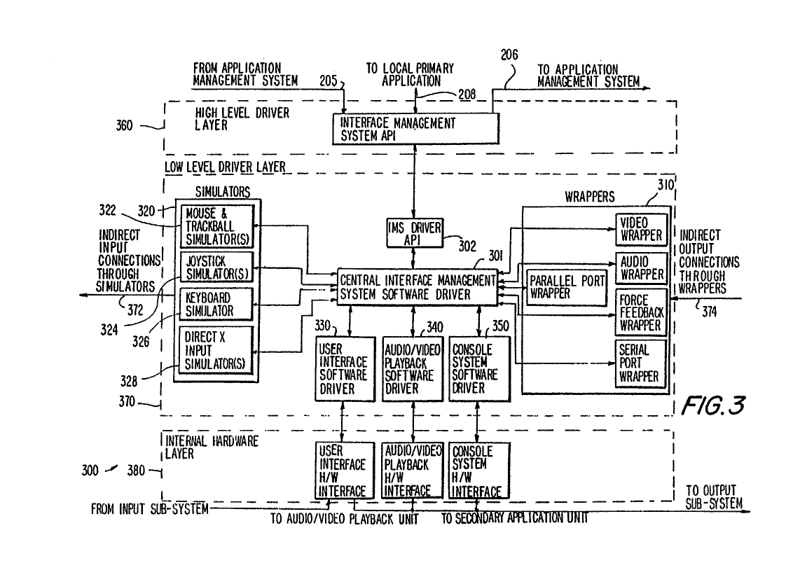

FIG. 3 shows a block diagram of IMS 300. IMS 300 supports the user control reconfigurability of both legacy and future applications. IMS 300 resides within the AECU 150 (see FIG. 2). The primary functional member of IMS 300 is the central interface management system software driver 301. This driver is responsible for supporting all input and output for MPIAE system 100 and for interfacing with console applications through console system software driver 350, and for future user drivers through user interface software drivers 330.

The IMS 300 consists of three layers. The high level driver layer 360 contains the IMS Application Programming Interface (hereafter IMS API) 360 which serves as a direct interface to the rest of the AECU 150 (see connection line 208). Future applications may also use this layer to directly control interfacing with system functions.

Low level driver layer 370 may provide services to the applications themselves. One of the primary tasks of this layer is to support legacy applications by allowing legacy applications to utilize system resources. The row of simulators 320 service applications in various ways by providing support for standard computer inputs including mice 322, joysticks 324, keyboards 326, and any other standard input device, i.e., Direct X 328. The row of wrappers 310 also service applications in various ways by intercepting application output (through connection line 374) that cannot be sent directly to the output subsystem and redirecting the output to the central interface management system software driver 301 for processing and re-direction to the output subsystem. The IMS Driver API 302, which provides a connection between IMS API 360 and the central interface management system software driver 301, is also accessible to future applications for direct control over the interface system and all of its functions.

The central interface management system software driver 301 coordinates and directs information passed between the wrappers 310 or the simulators 320 (i.e., mouse, joystick, etc.,) and the user interface 330, console system 350, and audio/video playback 340 drivers. The user interface software driver 330, the console system software driver 350, and the audio/video playback 340 are each responsible for direct communication and control over their respective devices. Other drivers may be added to the system as necessary. The Internal Hardware Layer 380 consists of hardware that is incorporated directly into the AECU of FIG. 1 and that is necessary for communication with the input subsystem 100, the local secondary application subsystem 120, and the output subsystem 130.

A block diagram of AMS 400 is shown in FIG. 4. It also resides in the AECU 150. AMS 400 configures the input and output subsystems through IMS 300 and coordinates launching of the application and tracking the state of the application. The Application State Manager 402 (ASM) calls on the application configuration manager 410 to configure the application properly. The application configuration manager 410 contains information about the application to be launched in three primary forks. The first is the application navigation script files 412. This script is a piece of software code that informs AMS 400 how to load, execute, control, and exit the application in question. It also contains information about what to do in the event of an application crash or other problem. The second fork is the application interfaces script files 414. This piece of software code preferably informs ASM 402 on how to configure the IMS 300. The third fork is the application manager startup file 416. This piece of software code informs AMS 400 on the location of all other files and resources required by the system including the application interface script files 414, the application navigation script files 412, and files containing any necessary calibration data. In addition, ASM 402 communicates with IMS 300 concerning the state and functionality of the program. Indirect state control of input subsystem 110 and output subsystem 130 is accomplished by ASM 402 via a path that utilizes the primary application 201 itself, as is indicated on FIG. 2 (see connection line 376 to local primary application and then connection line 204.) Finally, communication concerning the state of the application between ASM 402 and the primary application is controlled by the application management API 440.

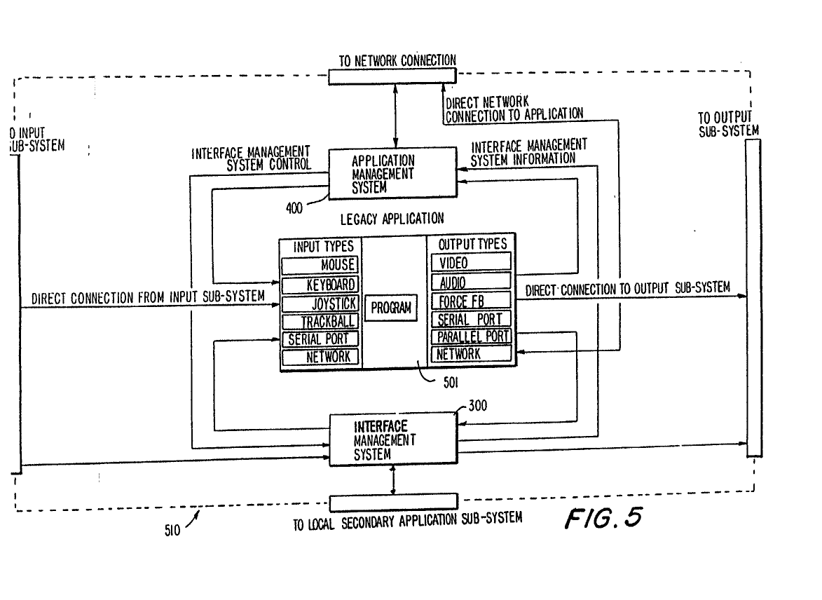

FIG. 5 shows an embodiment of the application execution and control unit 510 with a legacy application 501. As shown in FIG. 5, AMS 400 launches and executes a legacy application program 501. Because the application 501 is a legacy application, it is unaware of IMS 300 and the other added features of the MPIAE 100. In this case, AMS 400 makes assumptions about the configuration of the application based on information provided by application navigation script 412 and ASM 402. Typically, application navigation script 412 provides the configuration information for the legacy application. As described above, AMS 400 deals directly with IMS 300 and other systems on behalf of the application. This communication preferably involves selection of suitable drivers and hardware for a particular application.

In the future application connection mode it is assumed that the future application will be programmed to use the functionality of the input subsystem 110 or output subsystem 130 shown in FIG. 1. In this case the application has direct access to the lower level drivers such as the central interface management system software driver 301 and all the wrappers 310 and simulators 320 shown in low level driver layer 370 in FIG. 3, without having to use the wrappers or simulators.

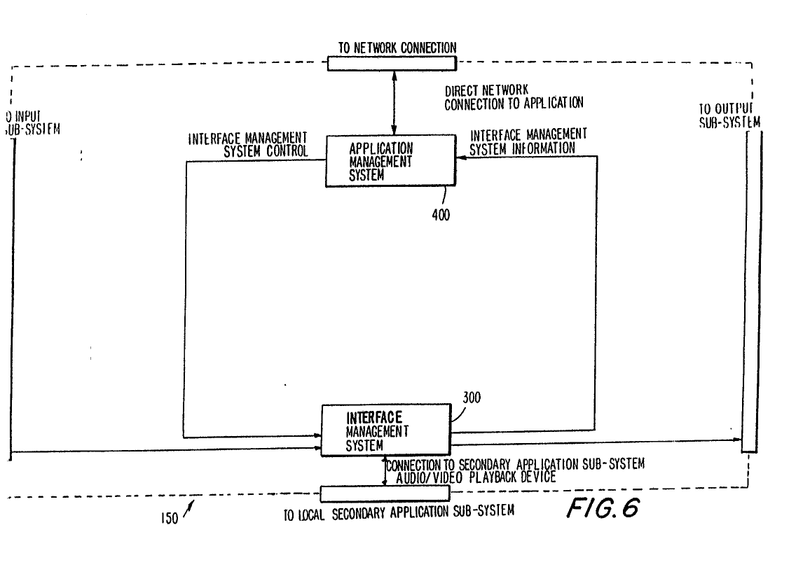

FIG. 6 shows AECU 150 in the console application connection mode. Here the application to be executed does not reside in the AECU 150 shown in FIG. 1, but rather in one of the local secondary application subsystem 120 (see FIG. 1). In this case AMS 400 controls launching, execution, and termination of the application completely through IMS 300. If the console application system hardware has been designed to be aware of the other MPIAE systems, it can control them through IMS 300. Otherwise, control of these systems is provided for by AMS 400 on behalf of the console application 122 (see FIG. 1) in the same way as for the legacy application described in reference to FIG. 5.

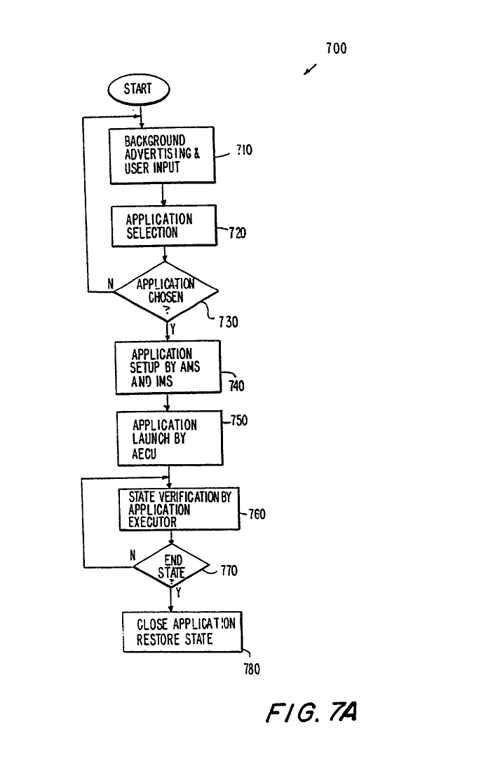

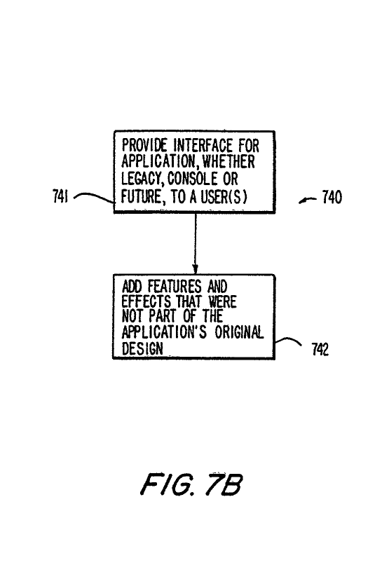

FIG. 7A shows a high level general software flowchart 700 followed by AECU 150, or some other suitable application executor, when selecting and executing an application. After boot up and initialization, AECU 150 displays background messages and images 710 that could be instructions or advertising. During this time, AECU 150 waits for user input to start the system. Once the user indicates the desire to run one of the applications (i.e., through the swiping of a debit card, insertion of a coin or other means) an application selection menu tree is displayed from which the user may choose the desired application (see box 720). If the user does not make a choice or chooses not to run an application, as shown by the N-branch leaving box 730, AECU 150 returns to the initial state. If a choice is made as shown with the Y-branch leaving box 730, AECU 150 accesses the application configuration manager 410 (see FIG. 4) and sets up IMS 300 with the proper control, input, and output settings, as shown in box 740, and shown in greater detail in FIG. 7B. Next AECU 150 launches the application and uses the application navigation information (if any) to get the user to the usable portion of the application. The application runs and AMS 400 monitors the entire system by verifying the state of the application, as shown in box 760. Once the “end” state is reached, as shown in box 770, the application is unloaded and the user controls, input system, and output systems are reset to their default values. System configuration is then reset to the initial state, as shown in box 780.

FIG. 7B is a flow chart 740 that corresponds to box 740 of FIG. 7A. Flow chart 740 shows additional steps that preferably provide part of the set up of the application. Step 741 shows the step of providing an interface for the application. Step 742 shows the optional step of providing additional features to the application that were not part of the original design of the application.

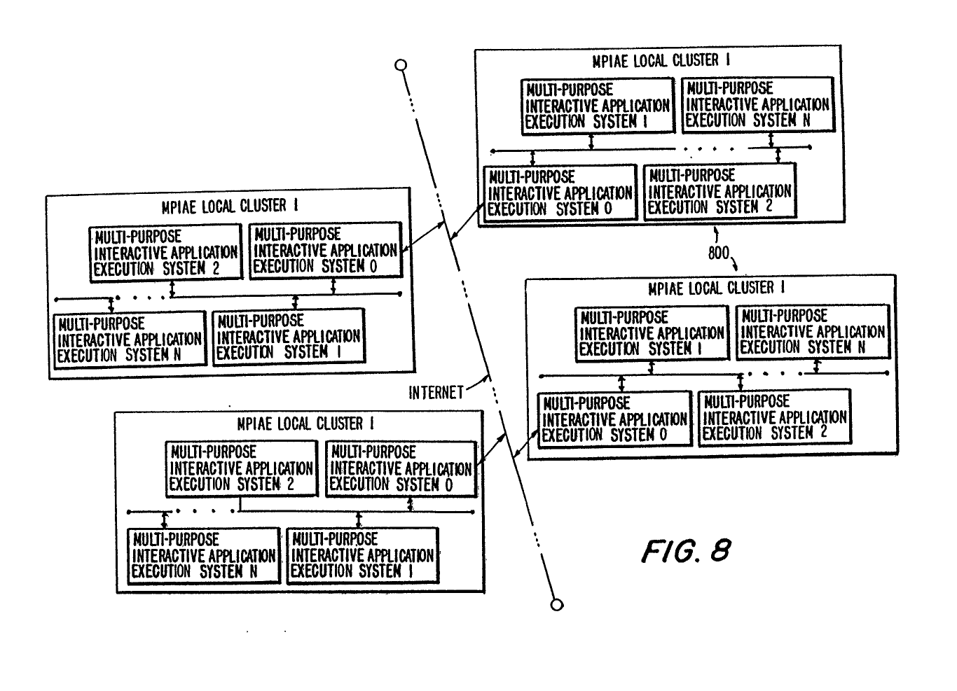

FIG. 8 shows local area MPIAE clusters 800 connected to the Internet. Internet configurability allows groups of MPIAE system users to compete with other groups at one or more remote locations. Application content written for this functionality enables communication between players across large distances. Each local MPIAE cluster 800 would have one system acting as the host for access to the Internet. Any of the clusters may serve applications or files to the other systems thus extending beyond the local area network the ability to have remote secondary application servers.

FIGS. 9-12 show one embodiment of the invention in a video game pod configuration. FIG. 9 shows the inner structure of a game pod 900 having a structural frame 910, with a screen 920 for viewing, and platforms 930 for placement of user controls.

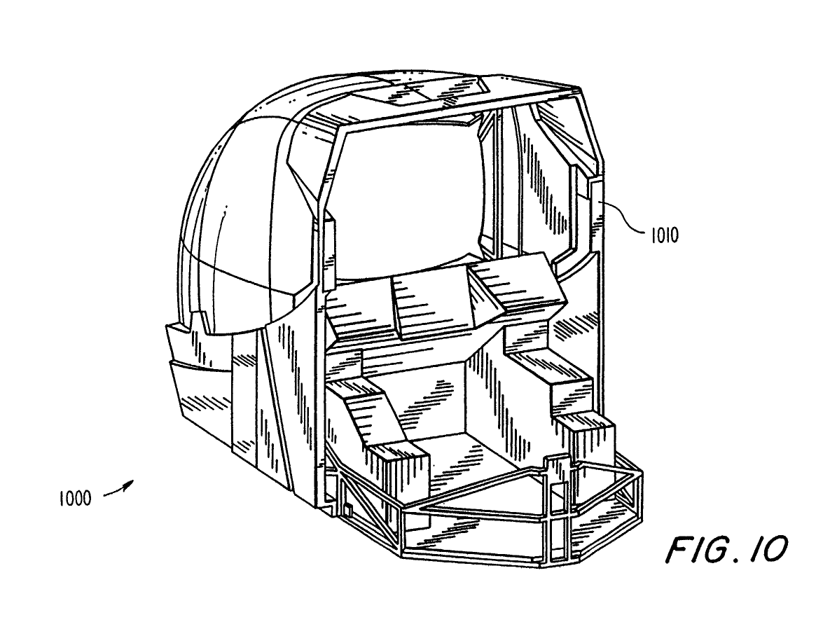

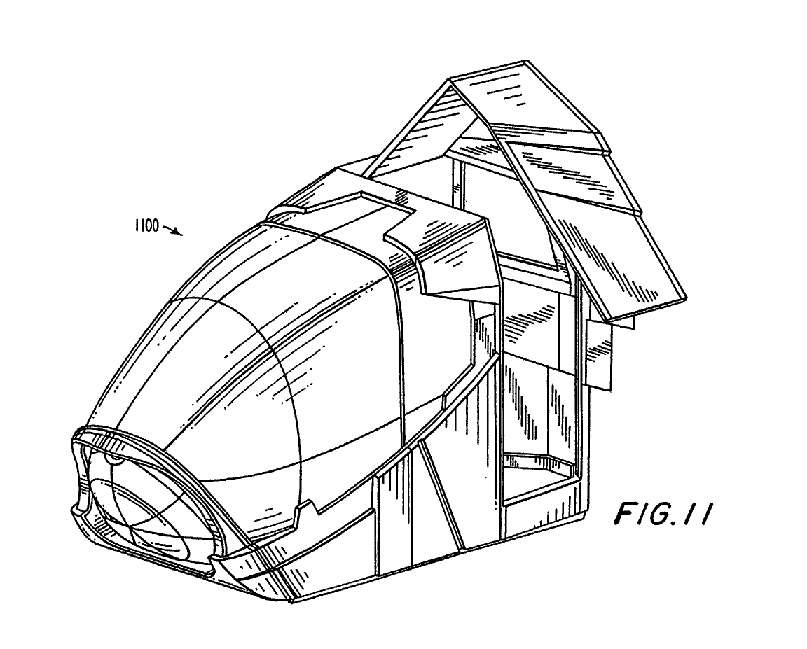

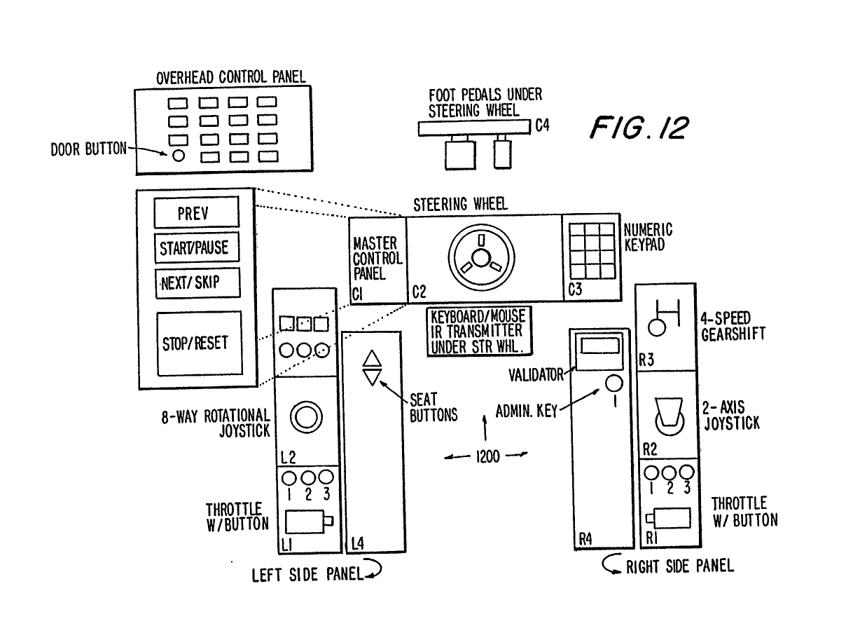

FIG. 10 shows a game pod 1000 partially encased in a molded fiberglass covering 1010. FIG. 11 shows the structural frame completely encased in a fiberglass molding 1100. FIG. 12 shows a possible configuration of the user controls 1200 for a video game pod configuration. In such a game pod, constructed according to the principles of the invention, a platform is preferably provided which can support applications having various software and hardware requirements.

Thus, a system capable of providing a platform for various software applications with differing hardware requirements has been provided. Persons skilled in the art will appreciate that the present invention can be practiced by other than the described embodiments, which are presented for purposes of illustration rather than of limitation, and the present invention is limited only by the claims which follow.

What is claimed is:

1. A multi-purpose interactive application execution system having hardware system resources and software system resources capable of supporting a variety of applications with different hardware and software resource requirements, for executing an application comprising:
a means for selecting said application;
a means for setting up said application based on said hardware and software system resources wherein said means for setting up communicates with said application and allocates said hardware and software system resources for use by said application;
a means for executing said application;
a means for verifying the state of said application;
a means for repeating said verifying step until an end state is reached in said application; and
a means for closing said application.

2. The system of claim 1 wherein said means for setting up further comprises a means for interfacing said application to a user.

3. The system of claim 1 wherein said means for setting up further comprises a means for adding at least one of 1) a new feature and 2) a new effect to said application.

4. The system of claim 1 wherein said means for setting up, said means for executing, said means for verifying, said means for repeating said verifying, and said means for closing are included in an application execution and control unit.

5. The system of claim 1 wherein said means for setting up, said means for executing, said means for verifying, said means for repeating said verifying, and said means for closing are included in a console application unit.

6. The system of claim 1 wherein said application is a legacy application.

7. A method for executing an application including:
selecting said one application from a variety of applications having different hardware and software resource requirements;
setting up a system based on currently available hardware and software system resources and allocating currently available hardware and software system resources for use by said application;
executing said application on said system;
verifying the state of said application;
repeating said verifying step until an end state is reached in said application; and
closing said application.

8. The method of claim 7 wherein said step of setting up further comprises interfacing said application to a user.

9. The system of claim 7 wherein said step of setting up further comprises adding at least one of 1) a new feature and 2) a new effect to said application.

10. The method of claim 7 wherein said steps of selecting, setting up, executing, verifying, repeating said verification, and closing said application are characterized by being performed on a console application unit.

11. The method of claim 7 wherein said steps of selecting, setting up, executing, verifying, repeating said verification, and closing said application are characterized by being performed on an application execution and control unit.

12. The method of claim 7 wherein said application is a legacy application.

13. A multi-purpose interactive application execution system for executing an application comprising:
an application execution and control unit;
an input subsystem for receiving input from a user, and adapting said input for use by said application execution and control unit;
an output subsystem for receiving output from said application execution and control unit, and adapting said output for use by a user;
a local secondary application subsystem for use by said application execution and control unit; and
a network communications unit for communication between said application execution and control unit and (1) one of an application and file server unit (2) at least one other multi-purpose interactive application execution system, (3) at least one multi-purpose interactive application execution server and (4) any other exterior systems.

14. The system of claim 13 wherein said application execution and control unit further comprises an application management system for coordinating between said input subsystem, said output subsystem, said local secondary application subsystem, and said network communications unit based on information found in an application configuration database.

15. The system of claim 14 wherein said application execution and control unit further comprises an interface management system which provides the ability to transfer information between said application management system and at least one of (1) said input subsystem, (2) said output subsystem, (3) said local secondary application subsystem, and (4) said network communications unit, and between said application and at least one of (1) said input subsystem, (2) said output subsystem, (3) said local secondary application subsystem, and (4) said network communications unit.

16. The system of claim 14 wherein said application configuration database further comprises:
application navigation script files for storing information concerning executing said applications,
application interface script files for storing information concerning setting up at least one user control of said application; and
application manager startup files for loading, launching, and executing said application.

17. The system of claim 13 wherein said application is a legacy application.

18. The system of claim 13 wherein said input subsystem comprises a control input unit for receiving a control input from a user control, and adapting said control input for use by said application execution and control unit.

19. The system of claim 13 wherein said input subsystem comprises a visual input unit for receiving a visual input from a user, and adapting said visual input for use by said application execution and control unit.

20. The system of claim 13 wherein said input subsystem comprises an audio input unit for receiving an audio input from a user, and adapting said audio input for use by said application execution and control unit.

21. The system of claim 13 wherein said input subsystem comprises a position input unit for receiving a position input from a user, and adapting said position input for use by said application execution and control unit.

22. The system of claim 13 wherein said output subsystem comprises a force feedback unit for receiving a force feedback output from said application execution and control unit, and adapting said force feedback output for use by a user.

23. The system of claim 13 wherein said output subsystem comprises a visual output unit for receiving a visual output from said application execution and control unit, and adapting said visual output for use by a user.

24. The system of claim 13 wherein said output subsystem comprises an audio output unit for receiving an audio output from said application execution and control unit, and adapting said audio output for use by a user.

25. The system of claim 13 wherein said output subsystem comprises a special effects unit for receiving special effects output from said application execution and control unit, and adapting said special effects output for use by a user.

26. The system of claim 13 wherein said output subsystem comprises a stereoscopic display unit for receiving stereoscopic display output from said application execution and control unit, and adapting said stereoscopic display output for use by a user.

27. The system of claim 13 wherein said output subsystem comprises an acceleration feedback unit for receiving an acceleration feedback output from said application execution and control unit, and adapting said acceleration feedback output for use by a user.

28. The system of claim 13 wherein said local secondary application subsystem comprises a video/audio playback unit.

29. The system of claim 13 wherein said local secondary application subsystem comprises a console application unit.

30. The system of claim 13 wherein said input subsystem comprises:
a control input unit for receiving a control input from a user control, and adapting said control input for use by said application execution and control unit;
a visual input unit for receiving a visual input from a user, and adapting said visual input for use by said application execution and control unit;
an audio input unit for receiving audio input from a user, and adapting said audio input for use by said application execution and control unit; and
a position input unit for receiving a position input from said user, and adapting said position input for use by said application execution and control unit,
and wherein said output subsystem comprises:
a force feedback unit for receiving a force feedback output from said application execution and control unit, and adapting said force feedback output for use by said user;
a visual output unit for receiving a visual output from said application execution and control unit, and adapting said visual output for use by said user;
an audio output unit for receiving an audio output from said application execution and control unit, and adapting said audio output for use by said user;
a special effects unit for receiving a special effects output from said application execution and control unit, and adapting said special effects output for use by said user;
a stereoscopic display unit for receiving a stereoscopic display output from said application execution and control unit, and adapting said stereoscopic display output for use by said user; and
an acceleration feedback unit for receiving an acceleration feedback output from said application execution and control unit, and adapting said acceleration feedback output for use by said user,
and wherein said local secondary application subsystem comprises a video/audio playback unit connected to said application execution and control unit and a console application unit connected to said application and control unit.
